(19) United States
(12) Patent Application Publication
(10) Pub. No.: US 2025/0046534 A1
(43) Pub. Date: Feb. 6, 2025

(54) CIRCUIT BREAKER DEVICE AND METHOD

(71) Applicant: Siemens Aktiengesellschaft, München (DE)

(72) Inventor: Marvin Tannhäuser, Hausen (DE)

(21) Appl. No.: 18/792,814

(22) Filed: Aug. 2, 2024

(30) Foreign Application Priority Data
Aug. 2, 2023 (DE) 10 2023 207 405.2
Sep. 28, 2023 (EP) 23200444.0

(51) Int. Cl. H01H 9/54

(52) U.S. Cl. CPC H01H 9/547

(57) ABSTRACT

A circuit breaker protects an electrical low-voltage circuit. The circuit breaker contains a mechanical isolating contact unit which is connected in series with an electronic interruption unit. The series circuit is connected at one end to a grid-side connection and at the other end to a load-side connection. The level of the current of the low-voltage circuit is determined. When the current and/or current/time limit-values are exceeded, a process for preventing a flow of current in the low-voltage circuit is initiated. The temperature at connection terminals of the circuit breaker is determined. When the level of the temperature exceeds a first temperature threshold value, the electronic interruption unit is switched to a high-impedance state of the switching elements for preventing a flow of current to prevent overheating of the connection terminals of the circuit breaker device.

### CROSS-REFERENCE TO RELATED APPLICATION

This application claims the priority, under 35 U.S.C. § 119, of German Patent Application DE 10 2023 207 405.2, filed Aug. 2, 2023; and European Patent Application EP 23200444.0, filed Sep. 28, 2023; both prior applications are herewith incorporated by reference in its entirety.

### FIELD AND BACKGROUND OF THE INVENTION

The invention relates to the technical field of a circuit breaker device for a low-voltage circuit having an electronic interruption unit, and to a method for a circuit breaker device for a low-voltage circuit having an electronic interruption unit.

Low voltage is understood to mean voltages of up to 1000 volts AC or up to 1500 volts DC. Low voltage is understood in particular to mean voltages that are greater than extra-low voltage, with values of 50 volts AC or 120 volts DC.

A low-voltage circuit or grid or installation is understood to mean circuits with nominal currents or rated currents of up to 125 amperes, more specifically up to 63 amperes. A low-voltage circuit is understood to mean in particular circuits with nominal currents or rated currents of up to 50 amperes, 40 amperes, 32 amperes, 25 amperes, 16 amperes or 10 amperes. The current values are understood to mean in particular nominal, rated or/and shutdown currents, that is to say the maximum current that is normally carried through the circuit or in the case of which the electrical circuit is usually interrupted, for example by a protection device, such as a circuit breaker device, miniature circuit breaker or power circuit breaker. The nominal currents may be gradated further, from 0.5 A through 1 A, 2 A, 3 A, 4 A, 5 A, 6 A, 7 A, 8 A, 9 A, 10 A, etc. up to 16 A.

Miniature circuit breakers are overcurrent protection devices that have long been known and that are used in low-voltage circuits in electrical installation engineering. They protect lines against damage caused by heating due to excessively high current and/or a short circuit. A miniature circuit breaker may automatically shut down the circuit in the event of an overload and/or short circuit. A miniature circuit breaker is not a fuse element that resets automatically.

In contrast to miniature circuit breakers, power circuit breakers are intended for currents greater than 125 A, in some cases also starting from 63 amperes. Miniature circuit breakers therefore have a simpler and more delicate design. Miniature circuit breakers usually have a fastening option for fastening to a so-called top-hat rail (carrier rail, DIN rail, TH35).

Miniature circuit breakers have an electromechanical design. In a housing, they have a mechanical switching contact or shunt opening release for interrupting (tripping) the electrical current. A bimetallic protection element or bimetallic element is usually used for tripping (interruption) in the case of a longer-lasting overcurrent (overcurrent protection) or in the event of a thermal overload (overload protection). An electromagnetic release with a coil is used for brief tripping if an overcurrent limit value is exceeded or in the event of a short circuit (short-circuit protection). One or more arc quenching chamber(s) or arc quenching devices are provided. Connection elements for conductors of the electrical circuit to be protected are also provided.

Circuit breaker devices having an electronic interruption unit are relatively recent developments. They have a semiconductor-based electronic interruption unit. In other words, the flow of electric current in the low-voltage circuit is guided via semiconductor components or semiconductor switches that are able to interrupt the flow of electric current or are able to be switched to the on state. Circuit breaker devices having an electronic interruption unit often also have a mechanical isolating contact unit, in particular with isolator properties in accordance with the applicable standards for low-voltage circuits. The contacts of the mechanical isolating contact unit are connected in series with the electronic interruption unit, i.e. the current of the low-voltage circuit that is to be protected is guided both through the mechanical isolating contact unit and through the electronic interruption unit.

The present invention can be used both for low-voltage DC circuits and for low-voltage AC circuits. The invention relates in particular to low-voltage AC circuits having an AC voltage, usually having a time-dependent sinusoidal AC voltage of frequency f. The temporal dependence of the instantaneous voltage value u(t) of the AC voltage is described by the equation:

$$u ( t ) = U * sin ( 2 π * f * t )$$

where:

u(t)=instantaneous voltage value at the time t

U=amplitude of the voltage.

A harmonic AC voltage can be represented by the rotation of a phasor, the length of which corresponds to the amplitude (U) of the voltage. The instantaneous deflection is in this case the projection of the phasor onto a coordinate system. An oscillation period corresponds to a full revolution of the phasor and its full angle is 2π (2pi) or 360°. The angular frequency is the rate of change of the phase angle of this rotating phasor. The angular frequency of a harmonic oscillation is always 2π times its frequency, that is to say:

ω=2π*f=2π/T=angular frequency of the AC voltage

(T=period duration of the oscillation).

It is often preferred to give the angular frequency (w) rather than the frequency (f), since many formulae in oscillation theory can be represented more compactly using the angular frequency due to the occurrence of trigonometric functions, the period of which is by definition 2π:

$$u ( t ) = U * sin ( ω t ) .$$

In the case of angular frequencies that are not constant over time, the term instantaneous angular frequency is also used.

In the case of a sinusoidal AC voltage, in particular an AC voltage that is constant over time, the time-dependent value formed from the angular velocity ω and the time t corresponds to the time-dependent angle φ(t) which is also referred to as the phase angle φ(t).

That is to say, the phase angle φ(t) periodically passes through the range 0 . . . 2π or 0° . . . 360°. That is to say, the phase angle periodically assumes a value of between 0 and 2π or 0° and 360° (φ=n*(0 . . . 2π) or φ=n*(0° . . . 360°) on account of periodicity; in abbreviated form: φ=0 . . . 2π or φ=0° . . . 360°).

The instantaneous voltage value u(t) is therefore used to mean the instantaneous value of the voltage at the time t, that is to say, in the case of a sinusoidal (periodic) AC voltage, the value of the voltage at the phase angle φ (φ=0 . . . 2π or φ=0° . . . 360°, of the respective period).

### SUMMARY OF THE INVENTION

The object of the present invention is to improve a circuit breaker device of the type mentioned at the outset, in particular to avoid destruction, damage or an impermissible operating state (in particular an impermissible operating temperature) of a circuit breaker device, in particular of the connection terminals thereof.

This object is achieved by a circuit breaker device having the features of the independent circuit breaker claim, and by a method as claimed in the independent method claim.

According to the invention, a circuit breaker device for protecting an electrical low-voltage circuit, in particular a low-voltage AC circuit, is proposed, containing:
a housing having at least two grid-side connections and at least one load-side connection, both for the low-voltage circuit,
the grid-sides connections and the at least one load-side connection each have connection terminals for connecting external (i.e. outside the circuit breaker device) conductors of the low-voltage circuit to be protected to the circuit breaker device,
a mechanical isolating contact unit, which is connected in series with an electronic interruption unit, wherein the series circuit is connected at one end to one of the at least two grid-side connections, and at the other end to the at least one load-side connection,
the mechanical isolating contact unit can be switched to prevent a flow of current by opening at least one contact, or to allow a flow of current in the low-voltage circuit by closing the at least one contact,
the electronic interruption unit can be switched by semiconductor-based switching elements to a high-impedance state of the switching elements to prevent a flow of current, or to a low-impedance state of the switching elements to allow the flow of current in the low-voltage circuit,
a current sensor unit for determining the level of the current in the low-voltage circuit, and
a control unit, which is connected to the current sensor unit, the mechanical isolating contact unit and the electronic interruption unit, wherein when the determined level of the current exceeds current and/or current/time limit-values (i.e. when a current level exists for a certain time), a process for preventing a flow of current in the low-voltage circuit is initiated, in particular by a high-impedance state of the switching elements of the electronic interruption unit.

According to the invention, a temperature sensor, which is connected to the control unit, is provided for determining the level of the temperature. The temperature sensor is provided at (on) or in the region of a connection terminal (or of connection terminals/of the connection terminals).

According to the invention, the circuit breaker device is embodied in such a way that when the determined level of the temperature (at least one connection terminal) exceeds a first temperature threshold value, the electronic interruption unit is switched to a high-impedance state of the switching elements for preventing a flow of current in order to prevent overheating of the connection terminal.

The high-impedance state interrupts the flow of current through the connection terminal(s) and therefore no further power is dissipated at the connection terminal, allowing it to cool down. Preventing overheating means that the connection terminal or the circuit breaker device remains within its permissible thermal limits or permissible (device) temperatures.

This has the advantage that overheating of the connection terminal(s) or the circuit breaker device is prevented. This can prevent thermal overload or thermal destruction. Protection against a device fire/fire in a subdistribution system can be provided. This provides reliability of supply. By preventing the flow of current, heating of the circuit breaker device is prevented and a safe state is established.

The root cause of the heating of a connection terminal lies essentially in the ever-present ohmic contact resistance, which together with the current flow (which flows through the connection terminal) leads to electrical power dissipation and associated heating at the connection terminal.

The electrical contact resistance of the connection terminal depends on various factors. For example, just (typically occurring) ageing can lead to an increase in the contact resistance. Corrosion, however, which can be exacerbated by the location of use (e.g. when used in environments containing corrosive gas or sea air (salt content)), also results in an increase in the contact resistance.

In addition, faulty installations such as an incorrect tightening torque (and in particular too low a tightening torque) for a screw terminal or an unsuitable conductor cross-section for a plug-in terminal (crimp terminal) are also possible causes of an increase in the contact resistance. A loose connection, for instance resulting from mechanical (over)stress, can likewise lead to an increase in the contact resistance at the connection terminal. Even simple dirt on the contact surfaces (for instance on account of improper handling during the installation) can lead to an increase in the contact resistance, however.

Further advantageous embodiments of the invention are specified in the subclaims and in the exemplary embodiment.

In an advantageous embodiment of the invention, at least one grid-side temperature sensor is provided for the grid-side connection terminals for the determining of the level of the temperature of the grid-side connection terminals.

One grid-side temperature sensor can be provided advantageously if, for example, two grid-side connection terminals lie next to one another. The grid-side temperature sensor can then be provided advantageously in the center of the two connection terminals.

In an advantageous embodiment of the invention, at least one load-side temperature sensor is provided for the at least one load-side connection terminal for the determining of the level of the temperature of the at least one load-side connection terminal.

In the case of two load-side connection terminals, one load-side temperature sensor can be provided advantageously if, for example, the two load-side connection terminals lie next to one another. The load-side temperature sensor can then be provided advantageously in the center of the two connection terminals.

In an advantageous embodiment of the invention, for each connection terminal, in particular of the current-carrying conductors of the low-voltage circuit, is provided one (connection-terminal associated) temperature sensor for the determining of the level of the temperature of the associated connection terminal.

This has the particular advantage of facilitating individual (critical connection terminals), essential (current-carrying connection terminals of the low-voltage circuit) and/or complete monitoring (all the connection terminals, if applicable individually) of the level of the temperature of the respective connection terminals. It is thereby possible to prevent overheating of the monitored connection terminal(s) and, as a result, of the circuit breaker device. This can prevent thermal overload or thermal destruction. Protection against a device fire/fire in a subdistribution system can be provided. By preventing the flow of current, heating of the circuit breaker device is prevented and a safe state is established.

In an advantageous embodiment of the invention, the mechanical isolating contact unit is assigned to the load-side connection, and the electronic interruption unit is assigned to the grid-side connection. In particular, the mechanical isolating contact unit can be operated by a mechanical handle in order to switch an opening of the at least one contact or a closing of the at least one contact.

This has the particular advantage that a structure for a circuit breaker device is provided in which the circuit breaker device can function even when the contacts of the mechanical isolating contact unit are open.

In an advantageous embodiment of the invention, two grid-side connections and two load-side connections are provided. In particular are provided a grid-side neutral conductor connection, a grid-side phase conductor connection, a load-side neutral conductor connection and a load-side phase conductor connection. This has the particular advantage that a structure for a two-pole circuit breaker device is provided, so that phase conductors and neutral conductors can be connected directly, and, for example, further neutral conductor rails can be omitted.

In an advantageous embodiment of the invention, at least one contact of the mechanical isolating contact unit is opened in the case of an initiated high-impedance state of the switching elements for preventing overheating and when the determined level of the temperature exceeds a higher second temperature threshold value (i.e. the second temperature threshold value is higher than the first temperature threshold value).

This has the particular advantage that an additional degree of safety is provided in the circuit breaker device. If there is increased heating despite an initiated high-impedance electronic interruption unit, this could be due to the fact that the electronic interruption unit is not or not sufficiently high-impedance and a (faulty) flow of current leads to further heating of the connection terminal(s). In this case, the at least one contact of the mechanical isolating contact unit is opened in order to achieve galvanic isolation and thus completely prevent the flow of current. This additional safety measure prevents the connection terminal(s)/the circuit breaker device from being destroyed.

In an advantageous embodiment of the invention, the electronic interruption unit is switched to a low-impedance state (for allowing a flow of current in the low-voltage circuit) in the case of a high-impedance state of the switching elements for preventing overheating and when the determined level of the temperature falls below a third temperature threshold value. The third temperature threshold value is lower than the first temperature threshold value.

This has the particular advantage that a flow of current is enabled again once the connection terminal(s) of the circuit breaker have cooled down. This means that the circuit breaker device is always in a safe operating state.

In an advantageous embodiment of the invention, alternatively, the electronic interruption unit is switched to the low-impedance state (for allowing a flow of current in the low-voltage circuit) in the case of a high-impedance state of the switching elements for preventing overheating and when a first time period has elapsed since the start of the high-impedance state of the switching elements (for preventing overheating).

For example, the first time period may be in the order of magnitude of 5 minutes, 10 minutes, 15 minutes, 20 minutes, 25 minutes, or 30 minutes.

This has the particular advantage that a fixed cooling time (first time period) is implemented. A flow of current is enabled again once the connection terminal(s) of the circuit breaker device have cooled down.

In an advantageous embodiment of the invention, the at least one contact of the mechanical isolating contact unit is opened in the event of a change to the high-impedance state for preventing overheating (and back to the low-impedance state), the change exceeding a first number, within a first time frame.

For example, the first time frame may be one hour, several hours, such as 3 hours, 5 hours, 6 hours, 10 hours, 12 hours, 18 hours, 24 hours (one day), several days, one week. For example, the number of changes can start from 2, 3, 4, . . . , 10, . . . 20.

This has the particular advantage that, in the event of a frequent temperature-related change to the high-impedance state (from the low-impedance to the high-impedance state), additional safety is implemented, and the at least one contact of the mechanical isolating contact unit is opened to perform galvanic isolation and completely prevent a heating flow of current. This prevents a further change to the high-impedance state (to the high-impedance state and back to the low-impedance state) of the electronic interruption unit and ensures safety in the low-voltage circuit.

In an advantageous embodiment of the invention, a communication unit, which is connected to the control unit, is provided. A warning is issued by means of the communication unit when a fourth temperature threshold value is exceeded. The fourth temperature threshold value is advantageously lower than the first temperature threshold value.

For example, the fourth temperature threshold value may be 10, . . . , 20, . . . , 30, . . . , 40 Kelvin lower than the first temperature threshold value.

This has the particular advantage that an notification is communicated when a temperature threshold value is reached, so that, for example or advantageously, a cause determination process can be carried out before a shutdown due to an overtemperature occurs.

Alternatively or additionally, the level of the temperature (or an equivalent) of the temperature sensor can be issued (communicated) by means of the communication unit.

This has the particular advantage that (central) temperature monitoring of one or more circuit breaker devices can be carried out, so that appropriate measures can be taken as temperatures rise.

In one advantageous embodiment of the invention, a display unit is provided, which is connected to the control unit and which has visible display means on the circuit breaker device for indicating the exceeding of temperature limits (first or/and second or/and third or/and fourth) or (and) the level of the temperature; alternatively or additionally, for indicating a high-impedance or low-impedance state of the electronic interruption unit.

This has the particular advantage that a visualization of the temperature state is provided.

In an advantageous embodiment of the invention, the at least one contact of the mechanical isolating contact unit can be opened, but not closed, by the control unit.

This has the particular advantage that the safety of the circuit breaker device is high, as the contact cannot be closed incorrectly (and not remotely, for instance by means of a communication signal) within the circuit breaker device.

In an advantageous embodiment of the invention, the at least one contact of the mechanical isolating contact unit has a release functionality. This may be a release functionality that is provided in accordance with current standards; in particular in such a way that the at least one contact can be opened by the control unit even if the mechanical handle is blocked, that is to say, for example, if the handle becomes/is blocked for the closed-contact state.

This has the particular advantage of providing a high level of safety and a circuit breaker device for low-voltage circuits that in particular is in line with standards. The flow of current can be interrupted galvanically at any time by opening the at least one contact.

According to the invention, a corresponding method for a circuit breaker device for a low-voltage circuit having electronic (semiconductor-based) switching elements is claimed that has the same and further advantages.

The method for a circuit breaker device for protecting an electrical low-voltage circuit, having:
a housing having at least two grid-side connections and at least one load-side connection,
the grid-side connections and the at least one load-side connection each have connection terminals for connecting external conductors of the low-voltage circuit to be protected to the circuit breaker device,
a mechanical isolating contact unit, which is connected in series with an electronic interruption unit, wherein the series circuit is connected at one end to one of the at least two grid-side connections, and at the other end to the at least one load-side connection,
the mechanical isolating contact unit can be switched to prevent a flow of current by opening at least one contact, or to allow a flow of current in the low-voltage circuit by closing the at least one contact,
the electronic interruption unit can be switched by semiconductor-based switching elements to a high-impedance state of the switching elements to prevent a flow of current, or to a low-impedance state of the switching elements to allow the flow of current in the low-voltage circuit,
the level of the current in the low-voltage circuit is determined, and when current and/or current/time limit-values are exceeded, a process for preventing a flow of current in the low-voltage circuit is initiated, and
the level of the temperature is determined at, or in the region of, at least one connection terminal, when the determined level of the temperature (at least one connection terminal) exceeds a first temperature threshold value, the electronic interruption unit is switched to a high-impedance state of the switching elements for preventing a flow of current in order to prevent overheating of the connection terminal.

All embodiments, both in dependent form referring back to the independent claims respectively and referring back only to individual features or combinations of features of claims, in particular also the dependent assembly claims referring back to the independent method claim (and vice versa), increase the safety of a circuit breaker device and provide a new concept for a circuit breaker device.

The following description of the exemplary embodiments will clarify and make more easily comprehensible the described properties, features and advantages of this invention, and the manner in which they are achieved, which exemplary embodiments are explained in greater detail in conjunction with the drawing.

Other features which are considered as characteristic for the invention are set forth in the appended claims.

Although the invention is illustrated and described herein as embodied in a circuit breaker device and a method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1A is a first schematic diagram of a circuit breaker device;

FIG. 1B is a second schematic diagram of the circuit breaker device;

FIG. 2 is a first illustration of a graph;

FIG. 3 is a second illustration of a graph;

FIG. 4 is a third illustration of a graph;

FIG. 5 is a fourth illustration of a graph; and

FIG. 6 is a fifth illustration of a graph.

### DETAILED DESCRIPTION OF THE INVENTION

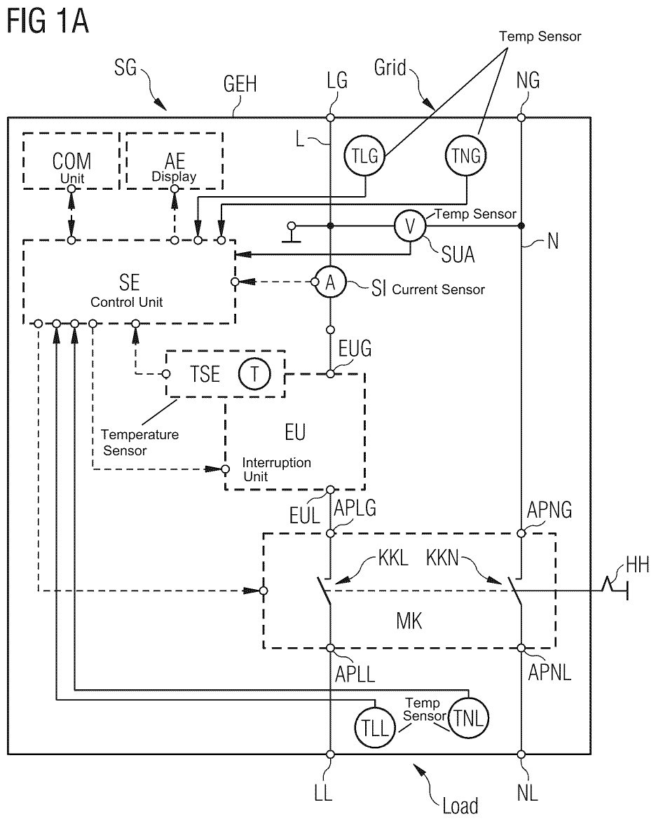

Referring now to the figures of the drawings in detail and first, particularly to FIG. 1A thereof, there is shown an illustration of a circuit breaker device SG for protecting an electrical low-voltage circuit, in particular a low-voltage AC circuit, having a housing GFH. The circuit breaker device contains:
a grid-side neutral-conductor connection terminal NG, a grid-side phase-conductor connection terminal LG, a load-side neutral-conductor connection terminal NL, a load-side phase-conductor connection terminal LL for connecting external conductors of the low-voltage circuit;
an energy source is usually connected to the grid side Grid, in the example by two grid-side connections;
a consumer (an energy sink) is usually connected to the load side Load, in the example by two load-side connections (although just one load-side connection can be provided, preferably for the phase conductor L);
a (two-pole) mechanical isolating contact unit MK having load-side connecting points APLL, APNL and grid-side connecting points APLG, APNG;
wherein for the neutral conductor is provided a load-side connecting point APNL, for the phase conductor is provided a load-side connecting point APLL, for the neutral conductor is provided a grid-side connecting point APNG, for the phase conductor is provided a grid-side connecting point APLG. The load-side connecting points APNL, APLL are connected to the load-side neutral-conductor and phase-conductor connection terminals NL, LL, so that opening of contacts KKN, KKL for preventing a flow of current, or closing of the contacts for allowing a flow of current in the low-voltage circuit can be switched;
the mechanical isolating contact unit can also be implemented as a single-pole mechanical isolating contact unit, i.e. having one contact, wherein the contact KKL is preferably arranged in the phase conductor L, and a neutral conductor N passing through the circuit breaker device SG is then not provided;
an, in particular single-pole, electronic interruption unit EU, (which for the single-pole implementation is arranged in particular in the phase conductor L), having a grid-side connection point EUG, which has an electrical connection to the grid-side phase-conductor connection terminal LG, and a load-side connection point EUL, which has an electrical connection, or is connected, to the grid-side connecting point APLG of the mechanical isolating contact unit MK;
wherein the electronic interruption unit has, by means of semiconductor-based switching elements, a high-impedance state of the switching elements to prevent a flow of current, or a low-impedance state of the switching elements to allow the flow of current in the low-voltage circuit;
a current sensor unit SI for determining the level of the current in the low-voltage circuit, which unit is arranged in particular in the phase conductor L;
a control unit SE, which is connected to the current sensor unit SI, the mechanical isolating contact unit MK and the electronic interruption unit EU, wherein when current and/or current/time limit-values are exceeded, a process for preventing a flow of current in the low-voltage circuit is initiated, preferably by way of a high-impedance state of the electronic interruption unit EU.

According to the invention, the circuit breaker device SG is embodied in such a way that at least one temperature sensor, which is connected to the control unit SE, is provided for determining the level of the temperature. The at least one temperature sensor is provided at, or in the region of, a connection terminal.

In the example shown in FIG. 1A:
the grid-side neutral-conductor connection terminal NG has a first grid-side temperature sensor TNG (=grid-side neutral-conductor temperature sensor TNG),
the grid-side phase-conductor connection terminal LG has a second grid-side temperature sensor TLG (=grid-side phase-conductor temperature sensor TLG),
the load-side neutral-conductor connection terminal NL has a first load-side temperature sensor TNL (=load-side neutral-conductor temperature sensor TNL), and
the load-side phase-conductor connection terminal LL has a second load-side temperature sensor TLL (=load-side phase-conductor temperature sensor TLL).

The temperature sensors are each connected to the control unit SE.

According to the invention, the circuit breaker device SG is embodied in such a way that when the level of the temperature (of (at least) one of the aforementioned temperature sensors of the connection terminals) exceeds a first temperature threshold value, the electronic interruption unit EU is switched to a high-impedance state of the switching elements for preventing a flow of current in order to prevent overheating of the connection terminals of the circuit breaker device.

In addition, a first voltage sensor unit SUA, which is connected to the control unit SE, can determine the level of the voltage, in particular instantaneous values of the level of the voltage, of the low-voltage circuit, in particular at the grid-side connection terminals LG, NG, specifically between grid-side neutral-conductor connection terminal NG and grid-side phase-conductor connection terminal LG. Advantageously, the switching of the electronic interruption unit EU to the low-impedance state takes place when the magnitude of the instantaneous value of the level of the voltage falls below a first voltage limit, which in particular is less than or equal to 50 volts (or 25 volts or 10 volts).

In general, the mechanical isolating contact unit MK and the electronic interruption unit EU form a series circuit. The series circuit is connected at one end to the at least one grid-side connection, and at the other end to the at least one load-side connection. The mechanical isolating contact unit MK can advantageously be assigned to the load-side connection, and the electronic interruption unit EU to the grid-side connection, as illustrated in FIG. 1A. The mechanical isolating contact unit MK can be operated by a mechanical handle HH in order to switch opening of contacts or closing of contacts, as in a conventional miniature circuit breaker (MCB).

The control unit SE may have a microcontroller (microcontroller unit).

In the example shown in FIG. 1A, the electronic interruption unit EU is implemented as a single-pole unit, in the phase conductor in the example. In this case, the grid-side connecting point APNG for the neutral conductor of the mechanical isolating contact unit MK is connected to the grid-side neutral-conductor connection terminal NG of the housing GEH. In the case of a single-pole variant of the circuit breaker device SG, this connection can be omitted, as can the neutral-conductor contact KKN of the mechanical isolating contact unit.

The circuit breaker device SG is advantageously embodied in such a way that the contacts of the mechanical isolating contact unit MK can be opened, but not closed, by the control unit SE, which is indicated by an arrow from the control unit SE to the mechanical isolating contact unit MK.

The mechanical isolating contact unit MK can be operated by a mechanical handle HH on the circuit breaker device SG in order to switch manual (hand-operated) opening or closing of the contacts KKL, KKN. The mechanical handle HH indicates (in the not-blocked state) at the circuit breaker device (specifically by means of a mechanical connection between contacts and handle) the switching state (Open or Closed) of the contacts of the mechanical isolating contact unit MK.

The mechanical isolating contact unit MK is advantageously embodied in such a way that (manual) closure of the contacts by the mechanical handle is possible only after an enable, in particular an enable signal. In other words, the contacts KKL, KKN of the mechanical isolating contact unit MK cannot be closed by the handle HH until the enable or enable signal (from the control unit SE) is present. Without the enable or enable signal, although the handle HH can be actuated, the contacts cannot be closed (“permanent slider contacts”).

The circuit breaker device SG has an energy supply NT (not shown), for instance a power supply unit. In particular, the energy supply NT is provided for the control unit SE. For example, the energy supply NT is connected to the grid-side neutral-conductor connection terminal NG and to the grid-side phase-conductor connection terminal LG. In the connection to the grid-side neutral-conductor connection terminal NG (or/and phase-conductor connection terminal LG) can be provided advantageously a cutout SS, in particular a fuse, or/and a switch.

In the case of a purely single-pole circuit breaker device, the energy supply is provided by an external energy source/additional connections.

High impedance is used to mean a state in which only a current of a negligible magnitude flows. In particular, high impedance is used to mean resistance values of greater than 1 kilohm, preferably greater than 10 kilohms, 100 kilohms, 1 megaohm, 10 megaohms, 100 megaohms, 1 gigaohm or greater.

Low impedance is used to mean a state in which the current value stated on the circuit breaker device could flow.

In particular, low impedance is used to mean resistance values of less than 10 ohms, preferably less than 1 ohm, 100 milliohms, 10 milliohms, 1 milliohm or less.

In a first variant, the mechanical isolating contact unit MK can interrupt in a single-pole manner. In other words, only one conductor (of the two/plurality of conductors), in particular the live conductor or phase conductor, is interrupted, i.e. has a mechanical contact. The neutral conductor then does not have any contacts, i.e. the neutral conductor is connected directly.

In a second variant of the mechanical isolating contact unit MK, the neutral conductor also has mechanical contacts (two-pole interruption), as shown in FIG. 1B.

A mechanical isolating contact unit MK is used to mean, in particular, a (standards-compliant) isolating function implemented by the isolating contact unit MK. An isolating function is used to mean the following points:
a) minimum clearance in air according to the standard (minimum distance between the contacts),
b) (mechanical) contact position indication of the contacts of the mechanical isolating contact system,
c) trip-free or release functionality, i.e. actuation to interrupt the contacts of the mechanical isolating contact unit is always possible by the handle or the control unit, so that (permanent) blocking of the contacts in the closed state by the handle is not possible.

In particular, trip-free or release functionality is used to mean that the at least one contact can be opened by the control unit even if the mechanical handle is blocked (e.g. in the On state).

In addition, the standards-compliant isolating function can include an ability to lock the isolating contact unit or the handle in the On or Off state.

The minimum clearance in air between the contacts of the isolating contact system is substantially voltage-dependent. Further parameters are the pollution degree, the type of field (homogeneous, inhomogeneous) and the barometric pressure and the height above sea level.

There are corresponding rules or standards for these minimum clearances in air or creepage distances. These rules specify, for example in air for an impulse withstand voltage, the minimum clearance in air for an inhomogeneous and a homogeneous (ideal) electrical field on the basis of the pollution degree. The impulse withstand voltage is the strength to withstand an applied corresponding impulse voltage. The isolating contact system or circuit breaker device has an isolating function (isolator property) only when this minimum length (minimum distance) is present.

In the context of the invention, in particular the DIN EN 60947 or IEC 60947 series of standards, to which reference is made here, are relevant to the isolator function and its properties.

The isolating contact system is advantageously characterized by a minimum clearance in air of the open isolating contacts in the OFF position (open position, open contacts) on the basis of the rated impulse withstand voltage and the pollution degree. The minimum clearance in air is, in particular, between (a minimum of) 0.01 mm and 14 mm.

In particular, the minimum clearance in air is advantageously between 0.01 mm at 0.33 kV and 14 mm at 12 kV, in particular for pollution degree 1 and in particular for inhomogeneous fields.

The minimum clearance in air can advantageously have the following values:

TABLE 13
Minimum clearances in air

| | Uᵢₘₚ | | | | | | | |
|---|---|---|---|---|---|---|---|---|
| | Minimum clearances in air | | | | | | | |
| | mm | | | | | | | |
| | | | | | Case B | | | |
| | Case A | | | | inhomogeneous | | | |
| Rated | inhomogeneous | | | | field, ideal | | | |
| impulse | field | | | | conditions | | | |
| withstand | (see 3.7.63) | | | | (see 3.7.62) | | | |
| voltage | pollution degree | | | | pollution degree | | | |
| kV | 1 | 2 | 3 | 4 | 1 | 2 | 3 | 4 |
| 0.33 | 0.01 | 0.2 | 0.8 | 1.6 | 0.01 | 0.2 | 0.8 | 1.6 |
| 0.5 | 0.04 | | | | 0.04 | | | |
| 0.8 | 0.1 | | | | 0.1 | | | |
| 1.5 | 0.5 | 0.5 | | | 0.3 | 0.3 | | |
| 2.5 | 1.5 | 1.5 | 1.5 | | 0.6 | 0.6 | | |
| 4.0 | 3 | 3 | 3 | 3 | 1.2 | 1.2 | 1.2 | |
| 6.0 | 5.5 | 5.5 | 5.5 | 5.5 | 2 | 2 | 2 | 2 |
| 8.0 | 8 | 8 | 8 | 8 | 3 | 3 | 3 | 3 |
| 12 | 14 | 14 | 14 | 14 | 4.5 | 4.5 | 4.5 | 4.5 |

NOTE
The specified minimum clearances in air are based on the 1.2/50 μs impulse voltage at an atmospheric pressure of 80 kPa, which corresponds to the atmospheric pressure at 2000 m above sea level

The pollution degrees and types of field correspond to those defined in the standards. This advantageously allows a standards-compliant circuit breaker device dimensioned according to the rated impulse withstand voltage to be achieved.

In particular, a mechanical isolating contact unit does not mean a relay contact.

The circuit breaker device may have an (in particular wireless) communication unit COM, which is connected to the control unit SE or is a part of it.

A warning can be issued by means of the communication unit COM when a fourth temperature threshold value is exceeded. Alternatively or additionally, the level of the temperature can be issued (communicated) by means of the communication unit COM. The issuing or communication of the exceeding of the temperature limit values or (and) the level of the temperature can be performed for the grid side Grid or (and) load side Load. The issuing or communication of the exceeding of the temperature limit values or (and) the level of the temperature can be performed alternatively or additionally for each temperature sensor.

A display unit AE can also be provided. The display unit AE can be embodied as a combined display and input unit. The display unit AE (display and input unit) is connected to, or is part of, the control unit SE. The display unit has display means visible on the circuit breaker device, in particular for displaying the high-impedance or low-impedance state of the electronic interruption unit EU; alternatively or additionally, for displaying the exceeding of temperature limit values (first or/and second or/and third or/and fourth) or (and) the level of the temperature. The displaying of the exceeding of the temperature limit values or (and) the level of the temperature can be performed for the grid side Grid or (and) load side Load. The displaying of the exceeding of the temperature limit values or (and) the level of the temperature can be performed alternatively or additionally for each temperature sensor.

For example, the circuit breaker device SG works on the principle that when contacts of the mechanical isolating contact unit are closed, and when the electronic interruption unit is low impedance, and
when a determined current is below a first current value, in particular is below the first current value for a first time limit, the electronic interruption unit EU becomes high impedance, and the mechanical isolating contact unit MK remains closed, or/and
when a determined current exceeds a higher second current value, in particular for a second time limit, the electronic interruption unit EU becomes high impedance, and the mechanical isolating contact unit MK is opened, or/and
when a determined current exceeds an even higher third current value, the electronic interruption unit becomes high impedance, and the mechanical isolating contact unit MK is opened.

The electronic interruption unit EU can have a further temperature sensor TSE located at the interruption unit. The function provided by this temperature sensor located at the interruption unit can be analogous to the temperature sensor(s) (TLG, TNG, TLL, TNL, TG, TL) located at the connection terminals.

FIG. 1B shows an illustration of a circuit breaker device as shown in FIG. 1A, with the difference:
that only one grid-side temperature sensor TG is provided for the (for instance two) grid-side connection terminals for determining the level of the temperature of the grid-side connection terminals. The grid-side temperature sensor TG is advantageously arranged between the (advantageously adjacent) grid-side connection terminals NG, LG, and
that only one load-side temperature sensor is provided for the (for instance two) load-side connection terminals for determining the level of the temperature of the load-side connection terminals. The load-side temperature sensor TL is advantageously arranged between the (advantageously adjacent) load-side connection terminals NL, LL.

The grid-side temperature sensor TG and the load-side temperature sensor TL are both connected to the control unit SE.

The manner of operation or working is analogous to that of FIG. 1A and is described below.

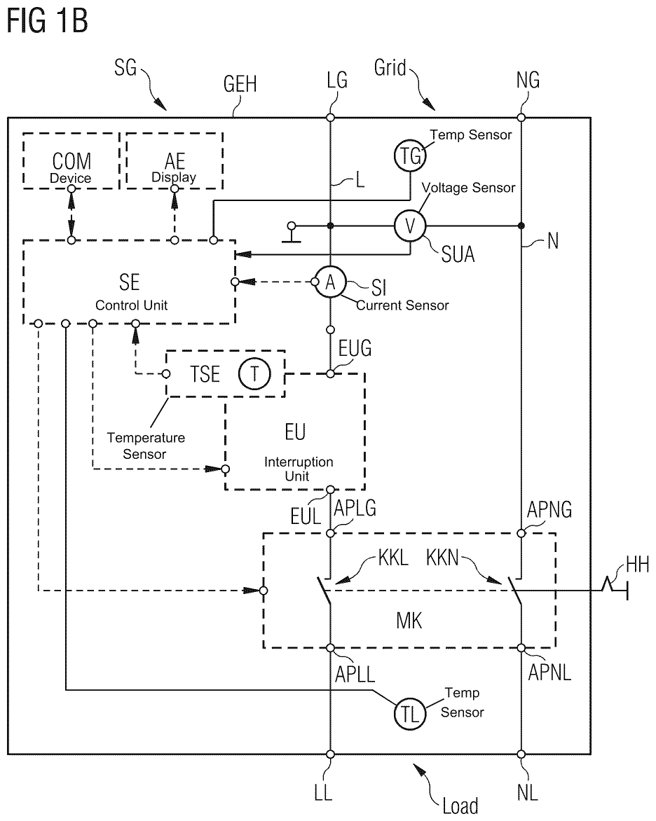

FIG. 2 shows an illustration of a first graph or coordinate system in which the level of the current I in the low-voltage circuit is plotted on the horizontal axis (abscissa), and the level of the temperature T_{TS} of one of the temperature sensors (located at the connection terminals) is plotted on the vertical axis (ordinate).

It shows the variation in the temperature T_{TS} of a (the particular) temperature sensor as a function of the level of the current I in the low-voltage circuit.

It is assumed here that the heating at a connection terminal is dependent on the level of the current I in the low-voltage circuit through the circuit breaker device (the circuit breaker device is intended to protect the low-voltage circuit). The temperature of the connection terminal rises as the level of the current I increases. Thus, the temperature T_{TS} of the circuit breaker device determined by the temperature sensor increases. The temperature increases monotonically with the level of the current. In addition to the level of the current, the ambient temperature also has an influence on the heating in the circuit breaker device. This is not shown in FIG. 2 for simpler illustration.

According to FIG. 2, various temperature threshold values are plotted: a first temperature threshold value 1.SW, in the example 100° C.; a second temperature threshold value 2.SW, in the example 110° C.; a third temperature threshold value 3.SW, in the example 80° C.

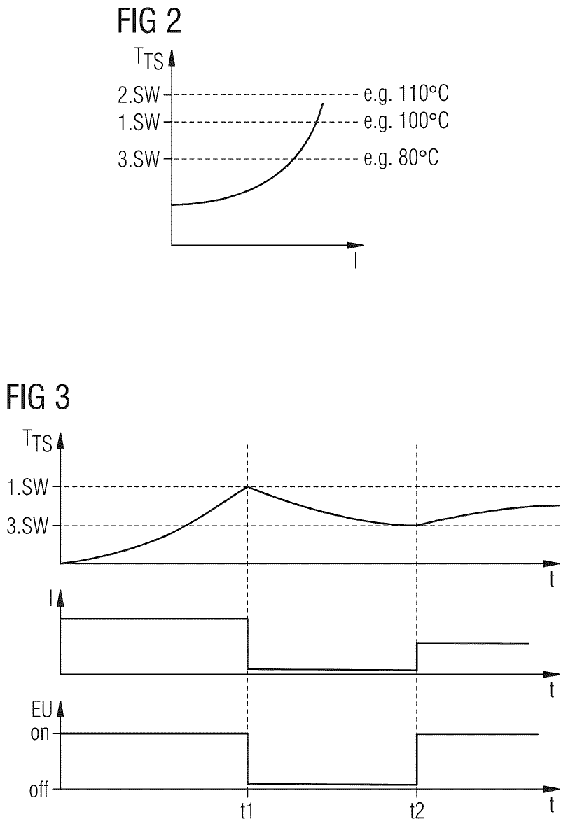

FIG. 3 shows an illustration according to FIG. 2, with the difference that three correlated graphs are shown, and the time t is plotted on the horizontal axis (abscissa).

In the upper region of FIG. 3, the level of the temperature T_{TS} of the (selected) temperature sensor is plotted as a function of time t. The first temperature threshold value 1.SW and the third temperature threshold value 3.SW are shown.

In the middle region of FIG. 3, the level of the current I is plotted as a function of time t.

In the lower region of FIG. 3, the switching state of the electronic interruption unit EU is plotted as a function of time t. A low-impedance state of the electronic interruption unit EU is denoted by on. A high-impedance state of the electronic interruption unit EU is denoted by off.

For example, a (constant) current I or a current I with a constant root mean square value of a first level for a certain time flows (center of FIG. 3). Corresponding heating occurs at the connection terminal. The temperature/the determined level of the temperature T_{TS} of the temperature sensor increases until the first temperature threshold value 1.SW is reached at the first time t1 (top of FIG. 3).

When the first temperature threshold value 1.SW is reached or exceeded, in the example 100° C., the electronic interruption unit EU is switched to a high-impedance state off (of the switching elements) in order to prevent a flow of current, first time t1 (bottom of FIG. 3). This prevents further heating and overheating (and associated damage) of the connection terminals.

The circuit breaker device and the connection terminal can cool down. At a second time t2, the third temperature threshold value 3.SW, in the example 80° C., is reached or undershot. When the third temperature threshold value 3.SW is reached or undershot, the electronic interruption unit is (again) switched (at the second time t2) to a low-impedance state on (for allowing a flow of current in the low-voltage circuit) (bottom of FIG. 3). The current I can (from the second time t2) flow again (center of FIG. 3). The temperature may rise again (top of FIG. 3).

The third temperature threshold value is lower than the first temperature threshold value.

Alternatively or additionally, instead of the third temperature threshold value 3.SW, it is possible to wait for a first period of time to elapse after the start of the high-impedance state of the switching elements. After a first period of time has elapsed since the start of the high-impedance state of the electronic interruption unit, the electronic interruption unit is switched to the low-impedance state (not shown).

If the change between the high-impedance state for preventing overheating and back to the low-impedance state is too frequent, the at least one contact of the mechanical isolating contact unit MK is opened. This means that the at least one contact of the mechanical isolating contact unit MK is opened in the event of a change (toggle) between the high-impedance state for preventing overheating and back to the low-impedance state, said change exceeding a first number, within a first time frame.

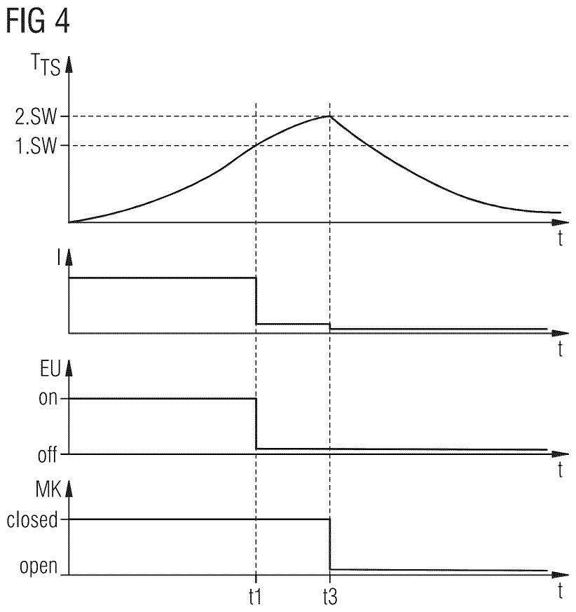

FIG. 4 shows an illustration according to FIG. 3, with the difference that it shows a fourth graph that correlates to the three upper graphs.

The fourth graph in the lowest region of FIG. 4 shows the switching state of the mechanical isolating contact unit MK as a function of time t. A closed state of the at least one contact of the mechanical isolating contact unit MK is denoted by closed. An open state of the at least one contact of the mechanical isolating contact unit MK is denoted by open.

Furthermore, the upper region of FIG. 4 shows the first temperature threshold value 1.SW and the second temperature threshold value 2.SW.

For example, a (constant) current I of a first level flows for a certain time (center of FIG. 4). Corresponding heating occurs at the connection terminal. The temperature in the circuit breaker device/the determined level of the temperature T_{TS} of the temperature sensor increases until the first temperature threshold value 1.SW is reached (top of FIG. 4) at the first time t1.

When the first temperature threshold value 1.SW is reached or exceeded, in the example 100° C., the electronic interruption unit EU is switched to a high-impedance state off (of the switching elements) in order to prevent a flow of current, first time t1 (bottom of FIG. 4).

The current is reduced (center of FIG. 4).

Even though the electronic interruption unit EU is switched to a high impedance, if the temperature now rises further, for example because the electronic interruption unit EU is defective (i.e. the high-impedance state is initiated, but, for example, is not or not fully effective) and a (lower) current flows, the at least one contact of the mechanical isolating contact unit MK is opened when the second temperature threshold value 2.SW, in the example 110° C., is reached or exceeded (bottom of FIG. 4), third time t3.

The second temperature threshold value 2.SW is higher than the first temperature threshold value 1.SW.

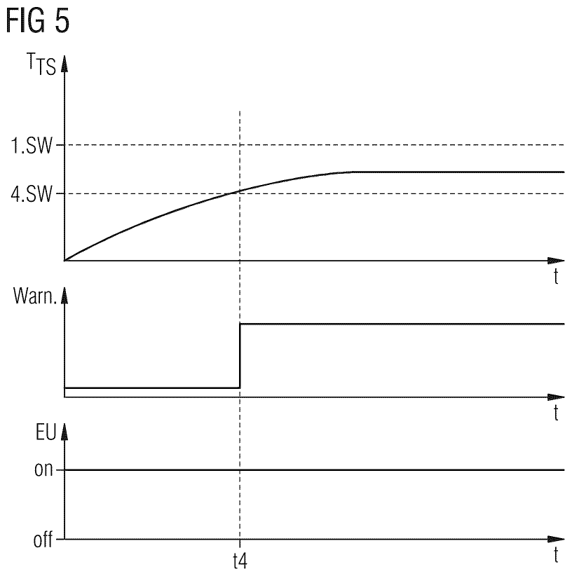

FIG. 5 shows an illustration according to FIG. 3, with the difference that the middle area of FIG. 5 shows the issuing of a warning Warn. as a function of time t.

Furthermore, the upper region of FIG. 5 shows the first temperature threshold value 1.SW and the fourth temperature threshold value 4.SW. If the fourth temperature threshold value is exceeded at the fourth time t4, a warning Warn. is issued (wirelessly/in wired fashion) by means of the communication unit COM. for example, to a higher-level management system. Alternatively or additionally, the warning can be displayed, for example by the display unit AE. The fourth temperature threshold value is lower than the first temperature threshold value.

The electronic interruption unit EU remains in the low-impedance state.

Alternatively or additionally, the level of the temperature can be issued (wirelessly/in wired fashion) by means of the communication unit COM, for example, to a higher-level management system. Alternatively or additionally, the level of the temperature can be displayed, for example by the display unit AE.

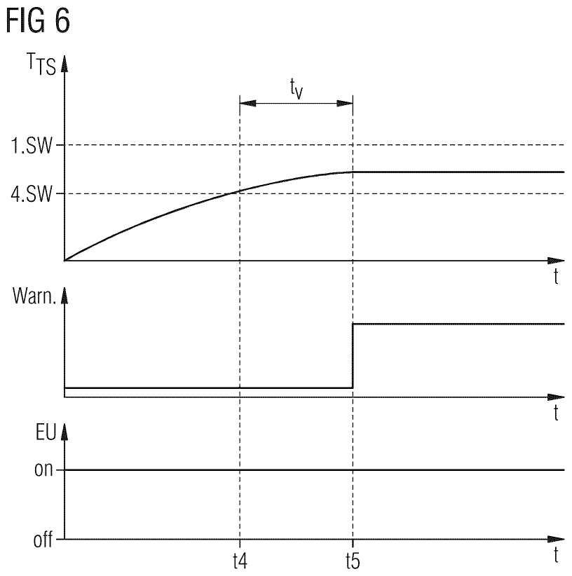

FIG. 6 shows an illustration according to FIG. 5, with the difference that the warning Warn. is issued with a time offset (time delay) t_{V}. This means that when the fourth temperature threshold value 4.SW is exceeded at the fourth time t4, no warning Warn. is issued, but the warning Warn. is only issued at a fifth time t5, as shown in FIG. 6. It is thus possible, for example, to avoid warnings based on short-term warming due to briefly increased start-up or switching currents. If the temperature T_{TS} has dropped below the fourth temperature threshold value 4.SW again before reaching the fifth time t5, no warning Warn. is issued.

The time offset (time delay) t_{V} is in the range from one second, . . . 5 seconds, . . . 10 seconds, . . . 1 minute.

The invention is explained again using different wording below.

An electrical (sub)distribution system contains a large number of different protective and switching devices, which are connected to one another via appropriate cables. When designing such a subdistribution system, thermal considerations and calculations must also be carried out, as losses occur in the subdistribution system due to ohmic losses on the lines and the electrical equipment. This heats up the subdistribution system. Today, thermal overload is prevented by appropriate (over)dimensioning (in accordance with standards, guidelines or regulations).

Apart from the aforementioned thermal designs of an electrical subdistribution system, the electrical connecting points (connection terminals) frequently lead to thermal overloads and fires. These can arise as a result of faulty commissioning (dirt, incorrect tightening torque in the case of screw terminals, loose connection terminal) or as a result of aging (corrosion).

Installer regulations and insurers today stipulate visual inspections by qualified electricians. However, these inspections may not find every faulty connection point.

According to the invention, a temperature measurement is implemented at (selected/the) connection terminals of the circuit breaker device. The temperature sensors and the additional device components are connected to the control unit, so that here a suitable algorithm can switch off the device before a hazardous temperature occurs at the connection points/connection terminals, and thereby protect the device/subdistribution system from a dangerous fire.

Recent electronic protective and switching devices use electronic switching elements (power semiconductors) in the main current path. When a critical temperature is reached, a high-impedance state is initiated. This means that current can no longer flow through the circuit breaker device and the connection terminal, and allows the connection terminal (and the subdistribution system) to cool down.

An appropriate warning message can also be issued.

Since current is no longer flowing through the device, the connection terminal and the device cools down again. Once the temperature has gone below a certain temperature, the device can automatically switch back to the low-impedance state for allowing a flow of current (hysteresis).

Depending on the device configuration, an opening of the contacts of the mechanical isolating contact unit can also be initiated instead of the low-impedance state. An automatic restart after cooling is then not possible. It is necessary to manually close the contacts again.

Although the invention has been described and illustrated in more detail by way of the exemplary embodiment, the invention is not restricted by the disclosed examples and other variations may be derived therefrom by a person skilled in the art without departing from the scope of protection of the invention.

1. A circuit breaker for protecting an electrical low-voltage circuit, the circuit breaker comprising:
a housing having at least two grid-side connections and at least one load-side connection, said grid-side connections and said at least one load-side connection each have connection terminals for connecting external conductors of the electrical low-voltage circuit to be protected to the circuit breaker;
an electronic interruption unit;
a mechanical isolating contact unit connected in series with said electronic interruption unit and defining a series circuit, wherein said series circuit is connected at a first end to one of said at least two grid-side connections, and at a second end to said at least one load-side connection, said mechanical isolating contact unit having at least one contact being switched to prevent a flow of current by opening said at least one contact, or to allow the flow of the current in the electrical low-voltage circuit by closing said at least one contact;
said electronic interruption unit having semiconductor-based switching elements and said electronic interruption unit being switched by said semiconductor-based switching elements to a high-impedance state of said semiconductor-based switching elements to prevent the flow of the current, or to a low-impedance state of said semiconductor-based switching elements to allow the flow of the current in the electrical low-voltage circuit;
a current sensor for determining a level of the current in the electrical low-voltage circuit;
a controller connected to said current sensor, said mechanical isolating contact unit and said electronic interruption unit, wherein when a determined level of the current exceeds current and/or current/time limit-values, a process for preventing the flow of the current in the electrical low-voltage circuit is initiated;
at least one temperature sensor connected to said controller and determining a level of a temperature, said at least one temperature sensor is disposed at, or in a region of, one of said connection terminals; and
the circuit breaker is embodied such that when the level of the temperature exceeds a first temperature threshold value, said electronic interruption unit is switched to the high-impedance state of said semiconductor-based switching elements for preventing the flow of the current to prevent overheating of said one connection terminal.

2. The circuit breaker according to claim 1, wherein:
said mechanical isolating contact unit is assigned to said at least one load-side connection; and
said electronic interruption unit is assigned to said at least two grid-side connections.

3. The circuit breaker according to claim 1, wherein said at least one load-side connection is one of two load-side connections and said at least two grid-side connections is two grid-side connections.

4. The circuit breaker according to claim 1, wherein said at least one contact of said mechanical isolating contact unit is opened in a case of an initiated high-impedance state of said semiconductor-based switching elements of said electronic interruption unit for preventing overheating and when a higher second temperature threshold value is exceeded.

5. The circuit breaker according to claim 1, wherein said electronic interruption unit is switched to the low-impedance state in a case of the high-impedance state of said semiconductor-based switching elements of said electronic interruption unit for preventing overheating and if a third temperature threshold value is undershot.

6. The circuit breaker according to claim 5, wherein the third temperature threshold value is lower than the first temperature threshold value.

7. The circuit breaker according to claim 1, wherein said electronic interruption unit is switched to the low-impedance state in a case of the high-impedance state of said semiconductor-based switching elements for preventing overheating, and when a first time period has elapsed since a start of the high-impedance state of said semiconductor-based switching elements for preventing overheating.

8. The circuit breaker according to claim 1, wherein said at least one contact of said mechanical isolating contact unit is opened in an event of a change to the high-impedance state for preventing overheating, said change exceeding a first number, within a first time frame.

9. The circuit breaker according to claim 1, further comprising a communication unit connected to said controller.

10. The circuit breaker according to claim 9, wherein said communication unit issues a warning when a fourth temperature threshold value is exceeded.

11. The circuit breaker according to claim 9, wherein the level of the temperature detected by said at least one temperature sensor or an equivalent is issued by means of said communication unit.

12. The circuit breaker according to claim 1, wherein said at least one contact of said mechanical isolating contact unit can be opened, but not closed, by said controller.

13. The circuit breaker according to claim 1, further comprising a mechanical handle, said mechanical isolating contact unit being operated by said mechanical handle to switch an opening of said at least contact or a closing of said at least one contact.

14. The circuit breaker according to claim 13, wherein said at least one contact of said mechanical isolating contact unit has a release functionality such that said at least one contact is opened by way of said controller, even if said mechanical handle is blocked.

15. The circuit breaker according to claim 1, further comprising at least one grid-side temperature sensor for said at least two grid-side connection terminals for determining of a level of a temperature of said at least two grid-side connection terminals.

16. The circuit breaker according to claim 1, further comprising at least one load-side temperature sensor for said at least one load-side connection terminal for determining of a level of temperature of said at least one load-side connection terminal.

17. The circuit breaker according to claim 1, wherein said at least one temperature sensor is one of a plurality of temperature sensors, one of said temperature sensors associated with each of said connection terminals for the external conductors of the electrical low-voltage circuit being current carrying conductors, for determining the level of the temperature of each of said connection terminals.

18. A method of using a circuit breaker for protecting an electrical low-voltage circuit, the circuit breaker comprising:
a housing having at least two grid-side connections and at least one load-side connection, the at least two grid-side connections and the at least one load-side connection each have connection terminals for connecting external conductors of the electrical low-voltage circuit to be protected by the circuit breaker;
a mechanical isolating contact unit connected in series with an electronic interruption unit defining a series circuit, wherein the series circuit is connected at a first end to at least one of the grid-side connections, and at a second end to the at least one load-side connection, the mechanical isolating contact unit being switched to prevent a flow of current by opening at least one contact of the mechanical isolating control unit, or to allow the flow of the current in the electrical low-voltage circuit by closing the at least one contact, the electronic interruption unit being switched by semiconductor-based switching elements to a high-impedance state of the semiconductor-based switching elements to prevent the flow of the current, or to a low-impedance state of the semiconductor-based switching elements to allow the flow of the current in the electrical low-voltage circuit;
which comprises the steps of:
determining a level of the current in the electrical low-voltage circuit;
initiating a process for preventing the flow of the current in the electrical low-voltage circuit when current and/or current/time limit-values are exceeded;
determining a level of a temperature at, or in a region of, at least one of the connection terminals; and
switching the electronic interruption unit to the high-impedance state of the semiconductor-based switching elements for preventing the flow of the current to prevent overheating of a connection terminal when the level of the temperature exceeds a first temperature threshold value.

19. The method according to claim 18, which further comprises opening the at least one contact of the mechanical isolating contact unit in a case of an initiated high-impedance state of the semiconductor-based switching elements for preventing overheating and when a higher second temperature threshold value is exceeded.

20. The method according to claim 18, which further comprises switching the electronic interruption unit to the low-impedance state in a case of the high-impedance state of the semiconductor-based switching elements for preventing overheating and if a third temperature threshold value is undershot.

21. The method according to claim 18, which further comprises switching the electronic interruption unit to the low-impedance state in a case of the high-impedance state of the semiconductor-based switching elements for preventing overheating, and when a first time period has elapsed since a start of the high-impedance state of the semiconductor-based switching elements for preventing overheating.

22. The method according to claim 18, which further comprises opening the at least one contact of the mechanical isolating contact unit in an event of a change to the high-impedance state for preventing overheating, the change exceeding a first number, within a first time frame.

23. The method according to claim 18, which further comprises issuing a warning when a fourth temperature threshold value is exceeded.

24. The method according to claim 18, which further comprises outputting the level of the temperature or an equivalent.
